(19) United States
(12) Patent Application Publication
(10) Pub. No.: US 2015/0222683 A1
(43) Pub. Date: Aug. 6, 2015

(54) Apparatus And Method For Associating Related Data From Multiple Sources

(71) Applicant: John J. Celona, Lake Worth, FL (US)

(72) Inventor: John J. Celona, Lake Worth, FL (US)

(21) Appl. No.: 14/616,540

(22) Filed: Feb. 6, 2015

Related U.S. Application Data
(60) Provisional application No. 61/936,846, filed on Feb. 6, 2014.

(51) Int. Cl. H04L 29/06

(52) U.S. Cl. CPC H04L 65/60; H04L 67/42

(57) ABSTRACT

A communication network in which data streams from multiple communication platforms are identified and cross-referenced with related information. Reports describing various aspects of the data streams are generated for the client associated with the data stream, by employers, or other authorized third parties. Consolidated reports can be generated for website interaction, web applications, email and/or SMS/MMS messages.

### CROSS-REFERENCE TO RELATED APPLICATIONS

This application is related to, and claims the benefit of, the provisional patent application entitled “Apparatus and Method for Associating Related Data From Multiple Sources”, filed Feb. 6, 2014, bearing U.S. Ser. No. 61/936,846 and naming John J. Celona, the named inventor herein, as sole inventor, the contents of which is specifically incorporated by reference herein in its entirety.

### BACKGROUND OF THE INVENTION

1. Technical Field

The present invention relates to data collection and monitoring systems. In particular, it relates to monitoring data from multiple data transmission sources to provide reports that provide a comprehensive overview of communications activities irrespective of the particular type of data transmission channels selected.

2. Background

Today, the Internet is responsible for only a small portion of the data traffic generated by individuals. Individuals can directly access websites on the Internet from their computers. Likewise, they can activate Internet applications from a variety of devices, not only from their computers, but also from other devices such as smart phones, gaming systems, etc. While a substantial amount of data traffic is generated by e-mail messages, there are also substantial amounts of data sent via telephone text messages, and SMS/MMS messages. Intelligent devices such as modern gaming systems, movie streaming systems (e.g. Netflix, etc.), home security systems, etc., produce large volumes of data related to, or directed to, a particular enterprise or individual.

Currently, commercial and/or government entities do not have the resources to analyze these multiple and divergent data streams. As a result, it is difficult to determine individual activities for the purpose of focusing services, such as advertising, in a precise manner for the purpose of obtaining the maximum possible advantage when accessing a particular market or class of individuals.

It would be desirable to have a method of monitoring multiple data streams for the purpose of correlating data related to those data streams such that the totality of the data threads can be understood.

In addition, it would be desirable to have a method of providing reports on the monitored data that cover the gist of the data regardless of the type of data stream selected by the user.

While the prior art has provided solutions related to individual data streams, it has failed to provide a comprehensive cross-platform monitoring and reporting system capable of relating data from multiple data streams and producing reports based on data related to an individual and/or an organization.

### SUMMARY OF THE INVENTION

The present invention provides a communication network in which information from multiple communication platforms is identified and cross-referenced with related information such that an overall picture of the data and activities at a particular user location or organization can be obtained.

### BRIEF DESCRIPTION OF THE DRAWINGS

FIG. 1 is a block diagram that illustrates multiple client application platforms communicating across a communications network, and a Web server that generates reports based on client communications from each of those platforms.

FIG. 2 is a flowchart illustrating the sequence of events in which a client directly accesses the communications network, transmits data across one or more platforms, and receives information related to data transmitted across those platforms.

FIG. 3 is a flowchart illustrating the sequence of events in which a client initiates an Internet publication that in turn accesses the communications network.

FIG. 4 is a flowchart illustrating the sequence of events in which client e-mail messages are analyzed, and the resulting analysis incorporated into reports related to that client.

FIG. 5 is a flowchart illustrating the sequence of events in which client SMS/MMS messages are analyzed, and the resulting analysis incorporated into reports related to that client.

### DESCRIPTION OF THE PREFERRED EMBODIMENT

Prior to a detailed discussion of the figures, a general overview of the invention will be presented. The invention provides a communications network that analyzes client data traffic that moves across multiple communications channels, such as direct Internet website access, intranet applications, e-mail data, SMS/MMS data. In addition, any electronic communications, such as texting, VOIP, graphics files, audio/video files, etc., can be folded into the communications network reporting system.

An advantage of using the reporting system is that it allows data transmitted by a particular individual or organization across one of the more data transmission channels to be monitored and analyzed independent of the transmission format. As a result, the individual client can obtain reports pointed to any number of specific issues related to the client. For example, a client can obtain reports to help understand how the client is using the system. This in turn could allow the client to adjust the client's usage to be more efficient. Likewise, if a client is an organization, it can generate reports related to specific departments and/or individuals to monitor their activity. An advantage of this system is that it can be used by individuals, by organizations, and/or by government entities to improve efficiency and productivity.

In addition to personal and business productivity advantages, the invention also provides government extra tools in regard to national security. In particular, the ability to monitor information transmitted across multiple data transmission channels provides monitoring agencies with comprehensive data related to particular events and individuals that might heretofore have not been connected.

In addition to self monitoring by clients, the invention provides an effective marketing tool for third parties in which data can be collected related to particular products, events, etc., to make commercial decisions related to the marketing of particular products or events. In the case of third parties, individual identifying information can be stripped from the data collection process such that only anonymous data is collected to protect the user's privacy.

Having discussed the features and advantages of the invention in general, we turn now to a more detailed discussion of the figures.

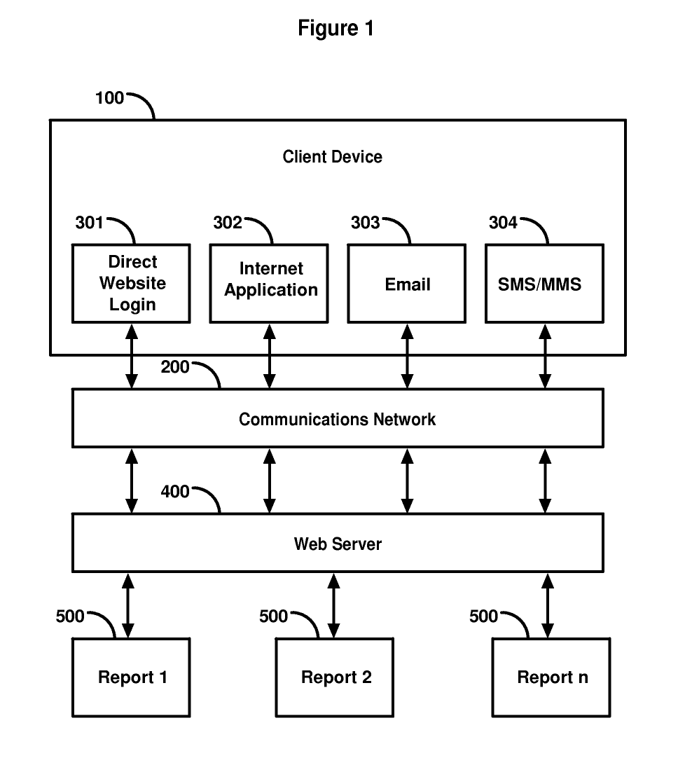

FIG. 1 is a block diagram that illustrates multiple client application platforms 301-304 communicating across a communications network 200, and a Web server 400 that generates reports based on client communications from each of those platforms. In each of the client application platforms 301-304, the applications are typically communicate with a central communication network 200 that acts as the communication up that connects to promote systems, servers, applications, etc.

My way of example, direct website logon 301 may be the situation where an individual accesses his personal bank account at the bank's website. An Internet application 302 maybe any website that is accessed by a user in which applications available to users can be initiated by remote individuals. E-mail 303 is an application that is widely used in which the messages generated and transmitted to one of more individuals on a one-way basis with no direction on the part of the client with the other system. Likewise SMS/MMS services 304 that are used by devices such as smart phones allow messages to be sent travel through the communications network to their selected destination. The term SMS services is used to describe the transmission of short messages, typically 160 characters or less, while the term MMS describes the transmission of multimedia messages that have no limit on size. All of these message types travel through the communications network 200.

Communications network 200 for provides communication services for the client application platforms 301-304, but also communicates with the Web server 400 that analyzes the data transmitted through the communications network 200 and makes determinations regarding the source of the data and its relevance to data transmitted from other sources. As a result of that analysis, reports can be generated that reveal patterns of activity that may be of interest to any of the issues of the system, whether they be individual clients, business entities, or government agencies, But would not necessarily be apparent if only one of the client application platforms 301-304 was monitored.

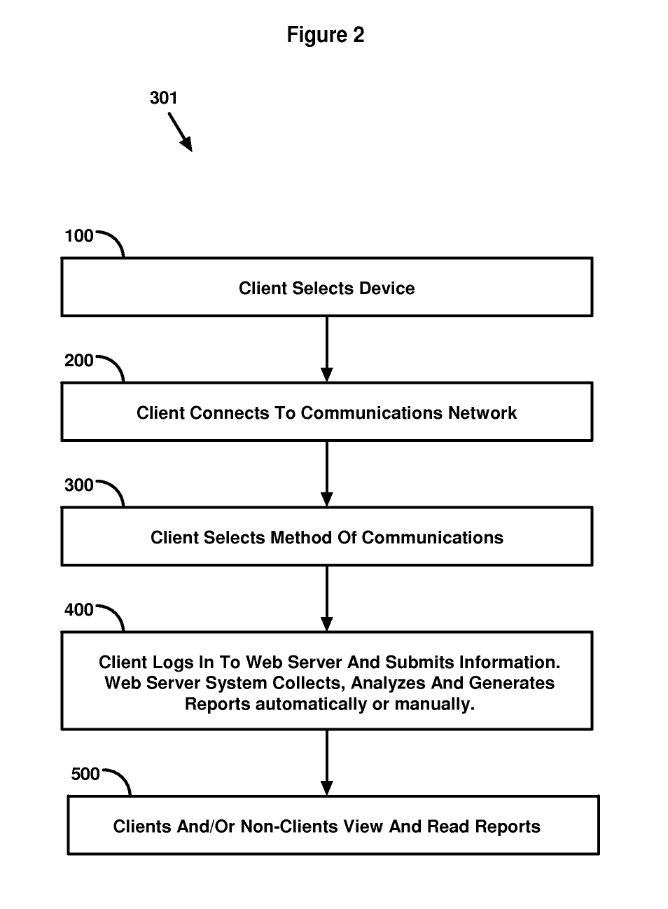

FIG. 2 is a flowchart illustrating the sequence of events for a direct website logon 301 in which a client directly accesses an Internet application. The client first selects a device at step 100. The device can be anything that can communicate with the Internet, such as a computer, a laptop, a tablet a smart phone, etc. Next, the client connects to the network at step 200. The connection process will vary depending on the nature of the device being used. At step 300, the client decides which method of communication is desired. It can be email, Internet access, etc. At step 400, the client then connects to the web server at step 400, which transmits the data to the intended destination, while simultaneously collecting data related to the transmission. At preselected times, the communications network 200 analyzes, and generates reports related to that data transmission and related data transmissions sent through this or other data channels. This can be done automatically, or under dynamic manual control. Once the reports are generated, the reports are analyzed at step 500 and sent to the appropriate parties. The system provides the of the ability for a client to analyze their own communications, for the client's company to analyze employee communications, or for government agencies, such as Homeland Security or law enforcement agencies, to monitor data activity across a spectrum of data channels and devices for the purpose of intercepting terrorist or criminal activity.

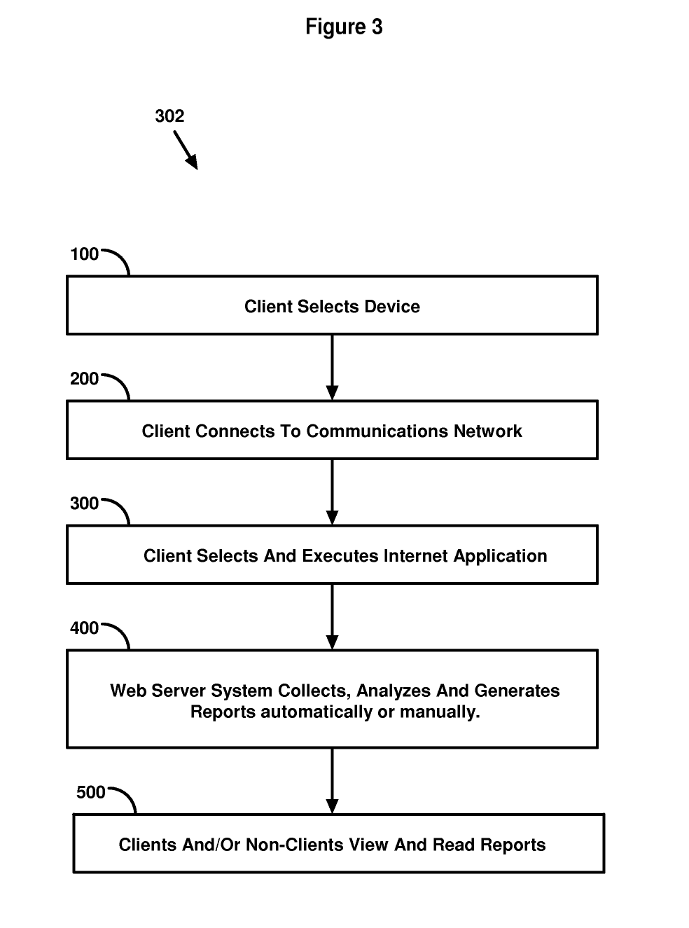

FIG. 3 is a flowchart illustrating the sequence of events in which a client initiates an Internet application that in turn accesses the communications network 200. As before, the client first selects a device at step 100. Next, the client connects to the network at step 200. It can be email, Internet access, etc. At step 400, the client then connects to the web server and decides which web application is to be executed. The web application then executes the selected function. At preselected times, the communications network 200 analyzes, and generates reports related to that web application and related data transmissions sent through this or other data channels. Again, this can be done automatically, or under dynamic manual control. Once the reports are generated, the reports are analyzed at step 500 and sent to the appropriate parties. The system provides the of the ability for a client to analyze their own communications, for the client's company to analyze employee communications, or for government agencies, such as Homeland Security or law enforcement agencies, to monitor data activity across a spectrum of data channels and devices for the purpose of intercepting terrorist or criminal activity. In the case of detected security issues, the system can automatically and dynamically generate reports for the responsible agency.

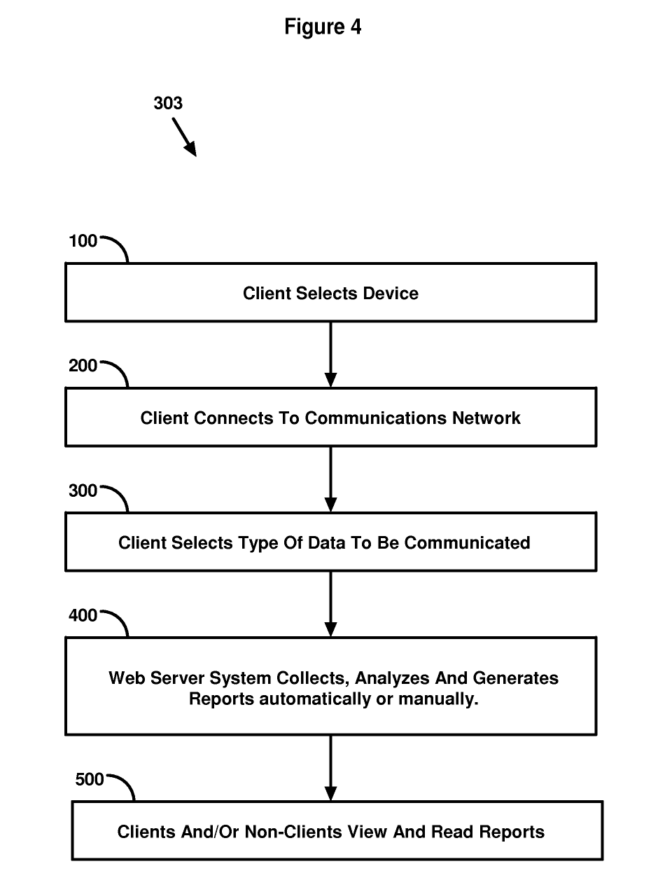

FIG. 4 is a flowchart illustrating the sequence of events in which client e-mail 303 messages are analyzed, and the resulting analysis incorporated into reports related to that client. As discussed above, the client first selects a device at step 100 and then connects to the network at step 200. The client initiates an email at step 300. At step 400, the client then connects to the web server and the email 303 is sent. At preselected times, the communications network 200 analyzes, and generates reports related to that web application and related data transmissions sent through this or other data channels. Again, this can be done automatically, or under dynamic manual control. Once the reports are generated, the reports are analyzed at step 500 and sent to the appropriate parties. The system provides the ability for a client to analyze their own communications, for the client's company to analyze employee communications, or for government agencies, such as Homeland Security or law enforcement agencies, to monitor data activity across a spectrum of data channels and devices for the purpose of intercepting terrorist or criminal activity. In the case of detected security issues, the system can automatically and dynamically generate reports for the responsible agency. In like manner, the system analyzes the email and generates reports that relate not only to the email, but also to any other type of related communications that were monitored.

In addition to the foregoing, the system also has the ability to analyze incoming emails from third parties and incorporate that data into reports related to the receiving party. As a result, the system can provide a picture of data activity going in both directions.

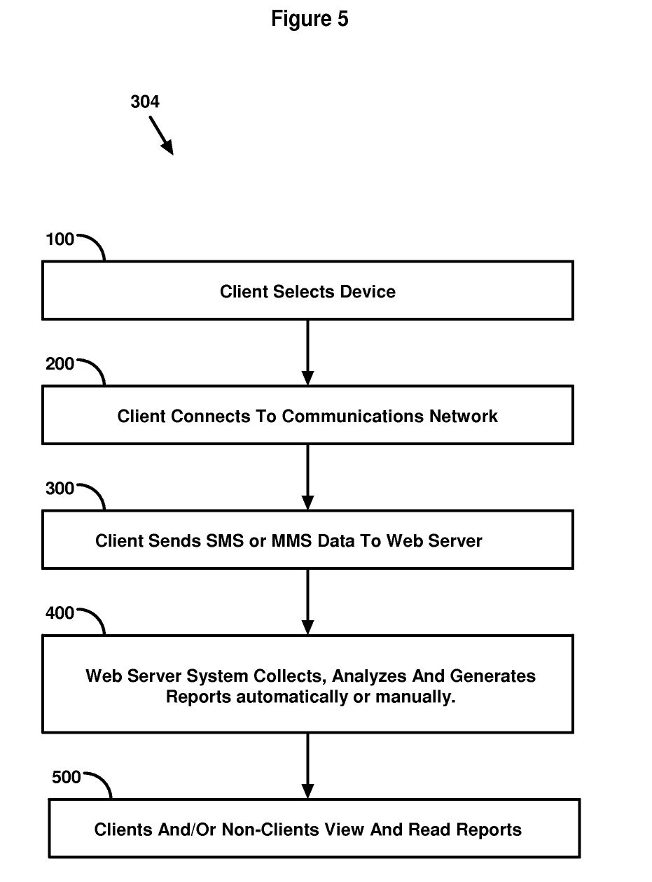

FIG. 5 is a flowchart illustrating the sequence of events in which client SMS/MMS messages 304 are analyzed, and the resulting analysis incorporated into reports related to that client. As discussed previously, the client first selects a device at step 100 and then connects to the network at step 200. The client initiates an SMS/MMS message at step 300. At step 400, the client then connects to the web server and the SMS/MMS 300 message is sent. At preselected times, the communications network 200 analyzes, and generates reports related to that SMS/MMS messages and related data transmissions sent through this or other data channels. As before, this can be done automatically, or under dynamic manual control. Once the reports are generated, the reports are analyzed at step 500 and sent to the appropriate parties. The system provides the ability for a client to analyze their own communications, for the client's company to analyze employee communications, or for government agencies, such as Homeland Security or law enforcement agencies, to monitor data activity across a spectrum of data channels and devices for the purpose of intercepting terrorist or criminal activity. In the case of detected security issues, the system can automatically and dynamically generate reports for the responsible agency. In like manner, the system analyzes the email and generates reports that relate not only to the SMS/MMS 300 message, but also to any other type of related communications that were monitored. As was the case above, the system generates reports related to this type of message along with any other type of related message.

For ease of discussion and illustration, FIGS. 2-5 have been shown for a single client. However, those skilled in the art will realize that the reports do not have to be limited to a single client. They can be consolidated reports that show the activity.

While the invention has been described with respect to a preferred embodiment thereof, it will be understood by those skilled in the art that various changes in detail may be made therein without departing from the spirit, scope, and teaching of the invention. The invention can be implemented on the Internet, on intranets, or on any other private network. For example, the types of data streams monitored, the types of reports generated, the control of access to the reports by the client or third parties may vary, etc. Accordingly, the invention herein disclosed is to be limited only as specified in the following claims.

I claim:

1. A method of monitoring data streams across a plurality of data platforms, including the steps of:
identifying the entity generating the data stream;
identifying data streams generated by that entity and transmitted via other data platforms;
creating a dataset of related information transmitted by a client across one or more data platforms; and
generating reports related to entity activity.

2. A method, as in claim 1, wherein:
the data platforms are Internet applications, intranet applications, private networks, email messages, SMS messages, and/or MMS messages.

3. A method, as in claim 1, including the additional step of:
using a communications network to monitor the data stream between a client and an Internet application.

4. A method, as in claim 3, including the step of:
generating reports related to data between the client and the Internet application, and/or data related to the Internet application.

5. A method, as in claim 4, including the step of:
transmitting the reports to the client, the client's organization, and/or a third party.

6. A method, as in claim 1, including the additional step of:
using a communications network to monitor the data stream between a client and the Internet.

7. A method, as in claim 6, including the step of:
generating reports related to data between the client and the Internet.

8. A method, as in claim 7, including the step of:
transmitting the reports to the client, the client's organization, and/or a third party.

9. A method, as in claim 1, including the additional step of:
using a communications network to monitor a client's email activity.

10. A method, as in claim 9, including the step of:
generating reports related to the client's email activity.

11. A method, as in claim 10, including the step of:
transmitting the reports to the client, the client's organization, and/or a third party.

12. A method, as in claim 1, including the additional step of:
using a communications network to monitor a client's SMS messages.

13. A method, as in claim 12, including the step of:
generating reports related to data in the client's SMS messages.

14. A method, as in claim 13, including the step of:
transmitting the reports to the client, the client's organization, and/or a third party.

15. A method, as in claim 1, including the additional step of:
using a communications network to monitor a client's MMS messages.

16. A method, as in claim 15, including the step of:
generating reports related to data in the client's MMS messages.

17. A method, as in claim 16, including the step of:
transmitting the reports to the client, the client's organization, and/or a third party.

18. A method, as in claim 1, including the additional step of:
using a communications network to monitor the data stream between a client and an Internet application, the Internet, the client's incoming and/or outgoing emails, the clients SMS messages, and/or MMS messages.

19. A method, as in claim 18, including the step of:
generating reports related to data between the client and the Internet application, and/or data related to the Internet application, the Internet, the client's incoming and/or outgoing emails, the clients SMS messages, and/or MMS messages.

20. A method, as in claim 19, including the step of:
transmitting the reports to the client, the client's organization, and/or a third party.
